(19) United States
(12) Patent Application Publication
(10) Pub. No.: US 2018/0376007 A1
(43) Pub. Date: Dec. 27, 2018

(54) IMAGE PROCESSING APPARATUS AND IMAGE EDITING SYSTEM FOR ADDING MOVING IMAGE DATA TO IMAGE DATA

(71) Applicants: KABUSHIKI KAISHA TOSHIBA, Tokyo (JP); TOSHIBA TEC KABUSHIKI KAISHA, Tokyo (JP)

(72) Inventor: Minoru SUZUKI, Sagamihara Kanagawa (JP)

(21) Appl. No.: 15/904,133

(22) Filed: Feb. 23, 2018

(30) Foreign Application Priority Data
Jun. 22, 2017 (JP) 2017-122270

(51) Int. Cl. H04N 1/00; H04N 1/047

(52) U.S. Cl. CPC H04N 1/00167; H04N 2201/04756; H04N 1/00161; H04N 1/047

(57) ABSTRACT

An image processing apparatus according to an embodiment includes an image reading device that generates image data by reading a sheet. A processor performs an editing processing on moving image data to generate edited moving image data. The processor generates synthesized image data by adding information corresponding to the edited moving image data to the generated image data. The image processing apparatus outputs the generated synthesized image data.

### CROSS-REFERENCE TO RELATED APPLICATION

This application is based upon and claims the benefit of priority from Japanese Patent Application No. 2017-122270, filed Jun. 22, 2017, the entire contents of which are incorporated herein by reference.

### FIELD

Embodiments described herein relate generally to an image processing apparatus and an image editing system for adding moving image data to image data.

### BACKGROUND

In an information processing apparatus such as a MFP (Multi-Functional Peripheral), an image editing function is provided. With the image editing function, it is possible to insert and synthesize other arbitrary images into an image scanned by the MFP or an image transferred from the information processing apparatus such as a personal computer. In the information processing apparatus, information relating to document data can be associated with the document data. The associated information can be reproduced at the time the document data is transferred. Recently, moving images have been used as the information associated with the document data. Generally, however, the moving image data has a larger size and transfer time. Therefore, even if the moving image data is associated with the document data, it takes substantial time to search a necessary part, and convenience may be reduced in some cases.

### DESCRIPTION OF THE DRAWINGS

FIG. 1 is an external view of an image processing apparatus according to a first embodiment;

FIG. 2 is a block diagram illustrating the functional components of the image processing apparatus according to the first embodiment;

FIG. 3 is a view illustrating an example of a screen for selecting moving image data associated with scan image data;

FIG. 4 is a view illustrating an example of a screen for determining an editing content of the selected moving image data;

FIG. 5 is a diagram illustrating an example of a screen for setting an association;

FIG. 6 is a diagram illustrating an example of synthesized image data;

FIGS. 7 and 8 are flowcharts illustrating a flow of processing of the image processing apparatus according to the first embodiment;

FIG. 9 is a diagram illustrating a general arrangement of an image editing system according to a second embodiment;

FIG. 10 is a block diagram illustrating the functional components of an image processing apparatus according to the second embodiment;

FIG. 11 is a block diagram illustrating the functional components of a moving image editing apparatus;

FIG. 12 is a flowchart illustrating the flow of a moving image data transmission processing by the image processing apparatus according to the second embodiment;

FIG. 13 is a flowchart illustrating the flow of a moving image editing processing of the moving image editing apparatus according to the second embodiment; and

FIG. 14 is a flowchart illustrating the flow of a moving image data synthesis processing of the image processing apparatus according to the second embodiment.

### DETAILED DESCRIPTION

An image processing apparatus according to an embodiment includes an image reading device that generates image data by reading a sheet. A processor performs an editing processing on moving image data to generate edited moving image data. The processor generates synthesized image data by adding information corresponding to the edited moving image data to the generated image data. The image processing apparatus outputs the generated synthesized image data.

Hereinafter, an image processing apparatus, and image editing system, and an image processing method of an embodiment is described with reference to the accompanying drawings.

### First Embodiment

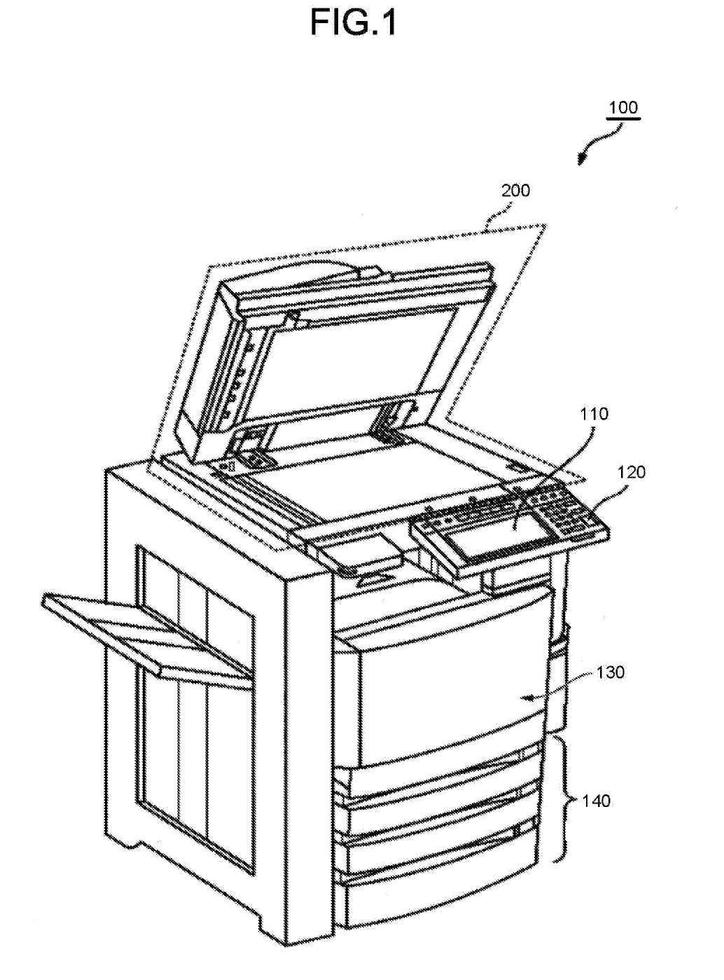

FIG. 1 is an external view of an image processing apparatus 100 according to the first embodiment.

The image processing apparatus 100 of the embodiment is, for example, a multi-functional peripheral capable of forming a toner image on a sheet. The sheet is, for example, an original document or a paper on which characters and images are recorded. The sheet may be any arbitrary object as long as the image processing apparatus 100 can read it. The image processing apparatus 100 reads an image shown on the sheet and generates digital data to generate an image file.

The image processing apparatus 100 includes a display 110, a control panel 120, a printer section 130, a sheet housing section 140 and an image reading section 200. Furthermore, the printer section 130 of the image processing apparatus 100 may be a device for fixing a toner image. In the present embodiment, a case in which the printer section 130 is a device for fixing the toner image is described as an example.

The display 110 is an image display device such as a liquid crystal display, an organic EL (Electro Luminescence) display and the like. The display 110 displays various information regarding the image processing apparatus 100. Further, the display 110 receives an operation by a user. The display 110 outputs a signal to a controller of the image processing apparatus 100 in response to the operation executed by the user.

The control panel 120 includes a plurality of buttons. The control panel 120 receives an operation by the user. The control panel 120 outputs a signal in response to the operation executed by the user to a controller of the image processing apparatus 100. Furthermore, the display 110 and the control panel 120 may be provided as an integral touch panel.

The printer section 130 executes an image forming processing. The printer section 130 forms an image on the sheet based on image data generated by the image reading section 200 or image data received through a communication path.

The sheet housing section 140 houses sheets used in the image formation by the printer section 130.

The image reading section 200 generates the image information by reading a reading object. For example, the image reading section 200 reads an image printed on a sheet which is the reading object set in the image processing apparatus 100. The image reading section 200 records the read image data. The recorded image data may be transmitted to another information processing apparatus via a network. The recorded image data may be used to form an image on the sheet by the printer section 130.

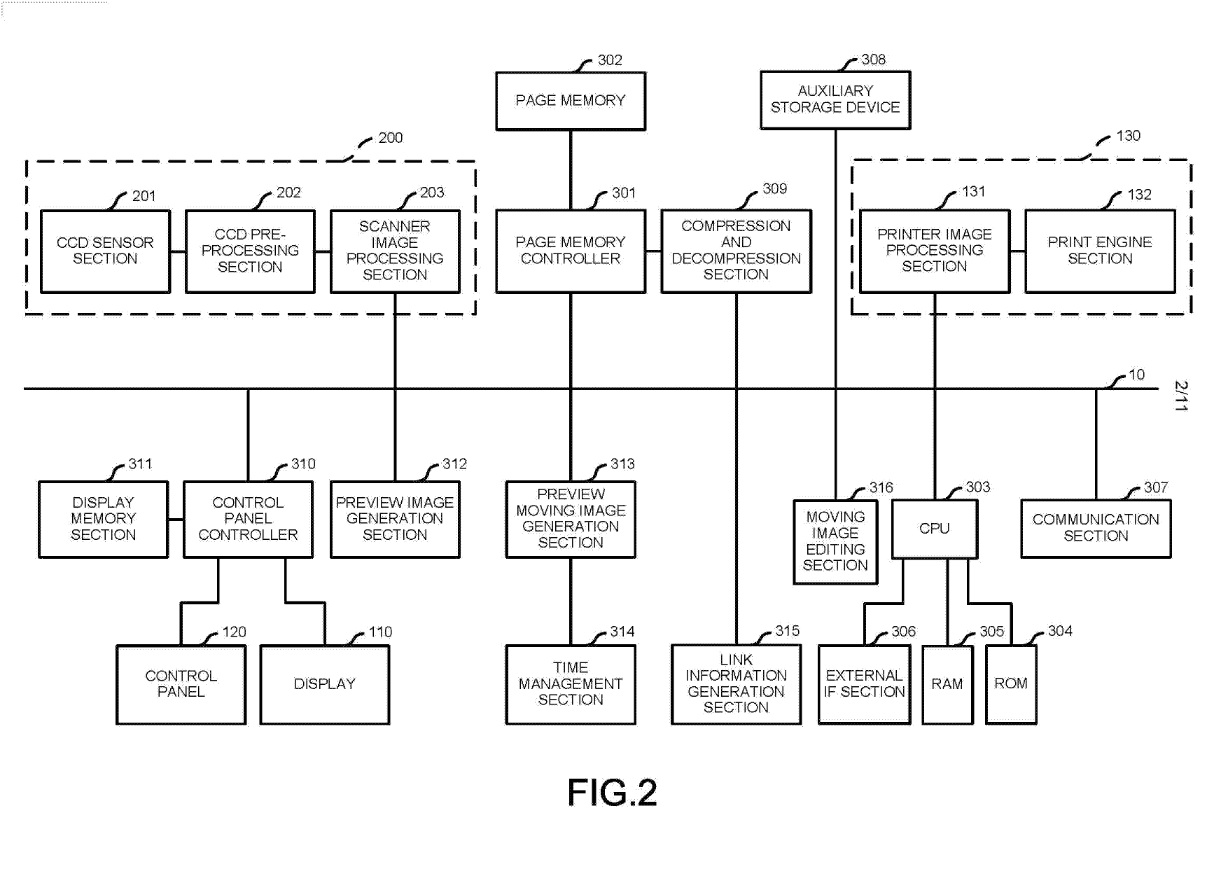

FIG. 2 is a block diagram illustrating the functional components of the image processing apparatus 100 according to the first embodiment. The printer section 130 includes a printer image processing section 131 and a print engine section 132. The image reading section includes a CCD sensor section 201, a CCD pre-processing section 202, and a scanner image processing section 203. The image processing apparatus 100 further includes a page memory controller 301, a page memory 302, a CPU 303, a ROM 304, a RAM 305, an external IF section 306, a communication section 307, an auxiliary storage device 308, a compression and decompression section 309, a control panel controller 310, a display memory section 311, a preview image generation section 312, a preview moving image generation section 313, a time management section 314, a link information generation section 315 and a moving image editing section 316. The preview image generation section 312, the preview moving image generation section 313, the time management section 314, the link information generation section 315 and the moving image editing section 316 are implemented by, for example, the CPU (Central Processing Unit) 303.

The printer image processing section 131 generates print data by executing an image processing necessary for printing. The image processing necessary for printing executed by the printer image processing section 131 includes a filter processing, a gradation processing, and the like.

The print engine section 132 executes printing control of the print data generated by the printer image processing section 131.

The CCD sensor section 201 reads a sheet with the CCD (Charge Coupled Device) and converts it to image data.

The CCD pre-processing section 202 carries out a processing of converting an analog signal at the time the CCD reads the sheet to a digital signal and generates a control signal for driving the CCD.

The scanner image processing section 203 generates scan image data from the image data by executing a necessary image processing. The image processing executed by the scanner image processing section 203 includes correction of characteristics of CCD elements, correction relating to an optical system of the image reading section 200, a range correction, a filter processing, and the like.

The page memory controller 301 writes and reads the scan image data to and from the page memory 302.

The page memory 302 temporarily stores page data for one or more pages. For example, the page memory 302 temporarily stores the scan image data.

The CPU 303 controls each hardware component and functional section according to a program stored in the ROM 304.

The ROM 304 is a read-only storage device. The ROM 304 stores programs executed by the CPU 303.

The RAM 305 is a readable and writable storage device. The RAM 305 temporarily stores data used in by the CPU 303 for various processing. For example, the RAM 305 is also used as a memory for executing data processing such as compression and decompression of moving image data.

The external IF section 306 is an interface for connecting to an external memory and the like. The external memory is, for example, a USB (Universal Serial Bus) memory.

The communication section 307 communicates with an external device connected to the network. The external device is an information processing apparatus such as a smartphone, a mobile phone, a tablet terminal, a notebook computer, a personal computer, a server, and the like. For example, the communication section 307 receives the moving image data from the external device.

The auxiliary storage device 308 is a storage device such as a magnetic hard disk device or a semiconductor storage device. The auxiliary storage device 308 stores the moving image data.

The compression and decompression section 309 compresses and decompresses the moving image data. For example, the compression and decompression section 309 compresses the moving image data and stores it in the auxiliary storage device 308. The compression and decompression section 309 also decompresses the moving image data stored in a compressed form.

The control panel controller 310 controls the display 110, the control panel 120, and the display memory section 311. The control panel controller 310 controls display of information on a predetermined screen and input of user operations through the touch panel. The control panel controller 310 controls the display 110 to display an image corresponding to image data stored in a display image area of the display memory section 311. The control panel controller 310 changes the image to be displayed on the display 110 by rewriting the display memory section 311.

The preview image generation section 312 processes and edits the scan image data according to a layout of the display on the display 110 to generate a preview image.

The preview moving image generation section 313 generates a frame image from the moving image data. The preview moving image generation section 313 processes and edits the moving image data according to a layout of the display on the display 110 to generate a preview image of the moving image data.

The time management section 314 manages the time/position in the moving image data with respect to the frame image generated as the preview image in the preview moving image generation section 313.

The link information generation section 315 generates information obtained by linking the scan image data with the moving image data and storage destination information of the moving image data. In the present embodiment, a file name of the moving image data and address information of the storage destination of the moving image data are stored in association with the scan image.

The moving image editing section 316 edits the moving image data based on information of a designated start position and end position. For example, the moving image editing section 316 edits the moving image data by deleting moving image parts other than the designated time in the moving image data. For example, the moving image editing section 316 extracts the moving image part corresponding to the designated time in the moving image data to edit the moving image data. Hereinafter, the moving image data edited by the moving image editing section 316 is referred to as edited moving image data.

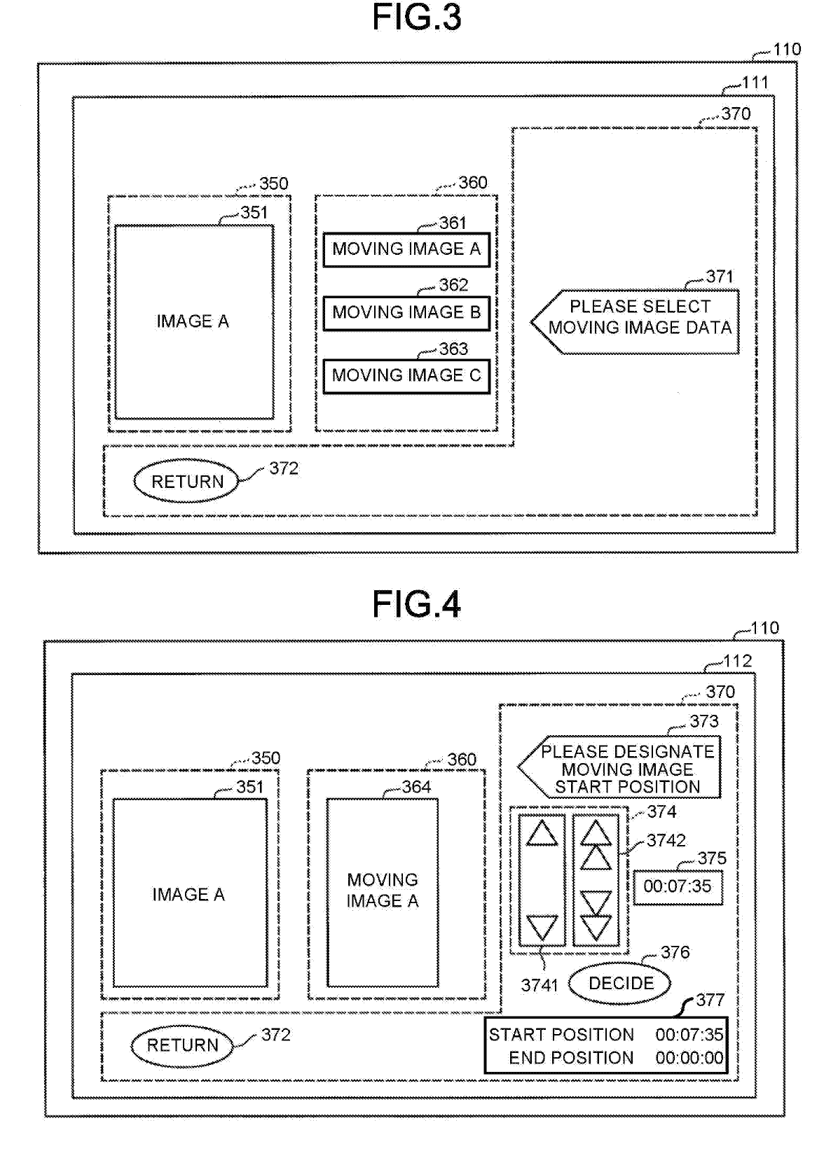

Next, an editing processing of the image processing apparatus 100 according to the present embodiment is described with reference to FIG. 3 to FIG. 6.

FIG. 3 is a diagram illustrating an example of a screen for selecting the moving image data to be associated with the scan image data. The user designates a scan mode for associating the moving image data with scanned image data of a sheet. A moving image selection screen 111 shown in FIG. 3 is displayed on the display 110 in which the moving image data is associated by the user and reading a sheet. Areas 350, 360, and 370 are displayed on the moving image selection screen 111. The areas displayed on the moving image selection screen 111 are set in advance according to format data. The control panel controller 310 displays information corresponding to each area according to the preset format data.

The area 350 displays the scan image data. The scan image data displayed in the area 350 is generated from the sheet read at the time the user executes the reading. In FIG. 3, an image A351 is displayed as the scan image data in the area 350.

The area 360 displays the information on the moving image data which are candidates to associate with the scan image data. The moving image data displayed in the area 360 is retrieved from the external memory or the auxiliary storage device 308. The moving image data stored in the external memory can be acquired via the external IF section 306. In FIG. 3, a moving image A 361, a moving image B 362 and a moving image C 363 are displayed as moving image data which are candidates in the area 360. The moving image data displayed in the area 360 may be displayed in a chronological order or may be displayed in any manner.

The area 370 is used for displaying information for operation by the user. In FIG. 3, in the area 370, instruction information 371 and a return button 372 are displayed. The instruction information 371 is an instruction to the user. For example, in the instruction information 371, information such as “Please select the moving image data.” is displayed. According to the display, the user is instructed to select the moving image data. The return button 372 is used for returning to the previous operation. If the return button 372 is pressed, the control panel controller 310 switches the screen of the display 110 from a currently displayed screen to a previous screen. If the moving image data is selected by the user (for example, the moving image A is selected), the control panel controller 310 switches the moving image selection screen 111 to a screen 112 shown in FIG. 4.

FIG. 4 is a view illustrating an example of a screen for determining editing contents of the selected moving image data. In an editing screen 112 shown in FIG. 4, a leading frame image of the selected moving image data is displayed in the area 360. In the area 370, a return button 372, instruction information 373, edited position adjustment buttons 374, adjusted position display information 375, a decision button 376, and range information 377 are displayed. For example, for the instruction information 373, information such as “Please designate a moving image start position” is displayed. According to the display, the user is instructed to select the position where the editing of the moving image data is started.

The edited position adjustment button 374 is used for adjusting the time positions set as the start and the end of the moving image data. In FIG. 4, as the edited position adjustment button 374, a first edited position adjustment button 3741 and a second edited position adjustment button 3742 are displayed. The first edited position adjustment button 3741 is used for changing the frame image of the moving image data by several units (for example, ±5 seconds) at a time. The second edited position adjustment button 3742 is used for changing the frame image of the moving image data by several tens of units (for example, ±30 seconds) at a time.

The adjusted position display information 375 indicates an adjusted position. In FIG. 4, “00:07:35” is displayed, indicating that the user selects “00: 07: 35” as the start position of the moving image data.

By operating the edited position adjustment button 374 by the user, a frame image corresponding to the position after the operation is displayed in the area 360. For example, as shown in FIG. 4, a processing of a case in which “00:07:35” is adjusted as the start position of the moving image data is described. The control panel controller 310 acquires the frame image corresponding to the position of “00: 07: 35” from the moving image data and displays the acquired frame image in the area 360.

The decision button 376 is used for setting the start position and the end position of the moving image data. If the decision button 376 is pressed, the position displayed in the adjusted position display information 375 is set as the start position or the end position.

The range information 377 indicates the start position and the end position. In an initial state, both the start position and the end position in the range information 377 are “00: 00: 00”. Every time the start position or the end position is set, the range information 377 is changed to the set information. In FIG. 4, the moving image start position designation method is described, but the moving image end position designation method is the same. If the end position is set, the control panel controller 310 switches the editing screen 112 to a screen 113 shown in FIG. 5.

FIG. 5 is a diagram illustrating an example of the screen for setting association. In a setting screen 113 shown in FIG. 5, only the information in the area 370 is changed from the editing screen 112. In the area 370, the return button 372, instruction information 378, set position information 379, a decision button 380, and edited information 381 are displayed. For example, in the instruction information 378, information such as “Do you edit and associate the moving image?” is displayed. According to the display, the user is instructed to select whether to edit and associate the moving image.

In the set position information 379, information on the start position and the end position set in the editing screen 112 is displayed. In FIG. 5, it is shown that the start position is “00: 07: 35” and the end position is “00: 12: 15”.

The decision button 380 is used for finalize editing the moving image data and to set the association. If the decision button 380 is pressed, an editing processing and an association processing of the moving image data are executed. The editing of the moving image data is a processing of generating the edited moving image data by excluding the moving image part other than the time designated by the start position and the end position from the moving image data. As specific examples of the editing processing of the moving image data, the following two examples are described:

1. A processing of deleting the moving image part other than the time designated by the start position and the end position from the moving image data to generate the edited moving image data; and

2. A processing of extracting the moving image part of the time designated by the start position and the end position from the moving image data to generate the edited moving image data.

In the following, a case is described in which the editing of the moving image data includes deleting the moving image part other than the time designated by the start position and the end position from the moving image data to generate the edited moving image data.

The processing of associating the moving image data represents a processing of associating the scan image data with the information corresponding to the edited moving image data. Specifically, first, the file name of the edited moving image data and the storage destination (e.g., storage address) of the edited moving image data are generated as association information. Next, synthesized image data is obtained by synthesizing the association information at a specific position of the scan image data. Then, the synthesized image data and the edited moving image data are stored in a position set in advance by the user.

The edited information 381 includes the name of the moving image data after editing and the storage destination. The edited information 381 may be set in advance or may be set by the user as appropriate.

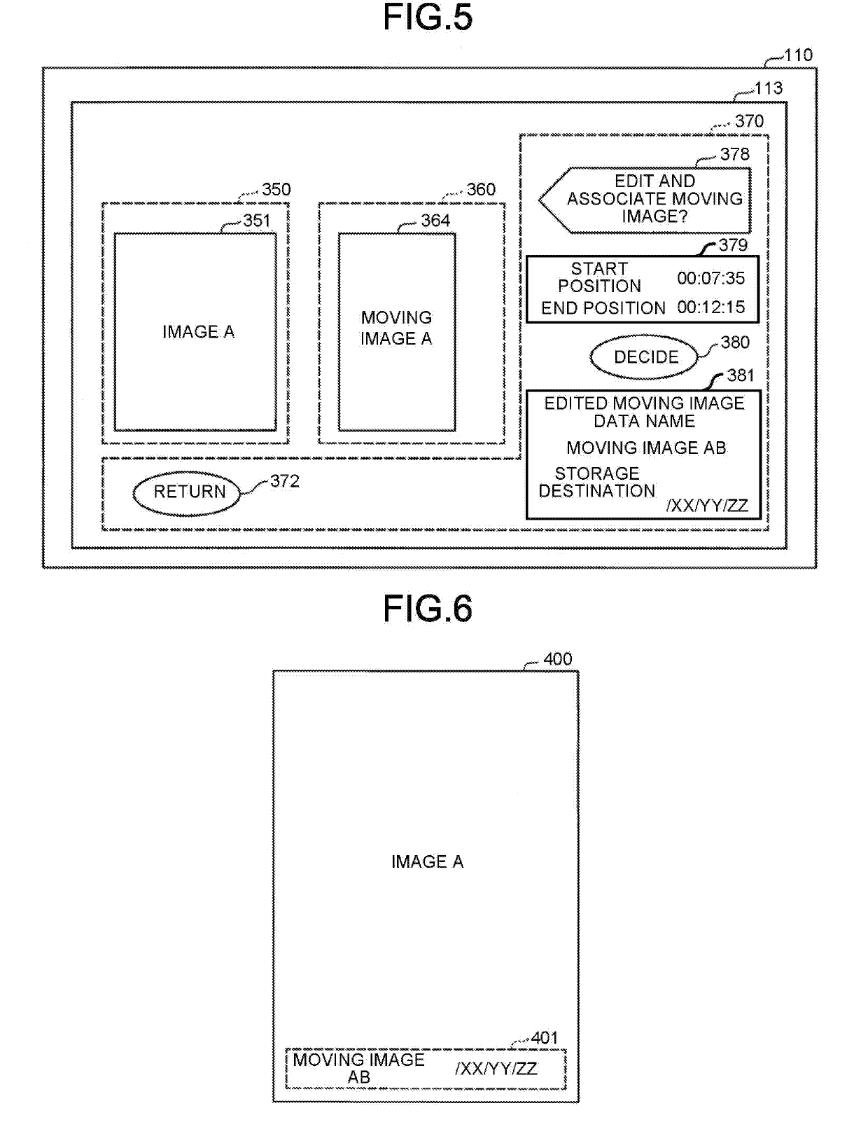

FIG. 6 is a diagram illustrating an example of the synthesized image data generated by the processing shown in FIG. 3 to FIG. 5. As shown in FIG. 6, association information 401 is synthesized at the specific area (for example, header or footer) of scan image data 400. As a result, the user can easily refer to the association information.

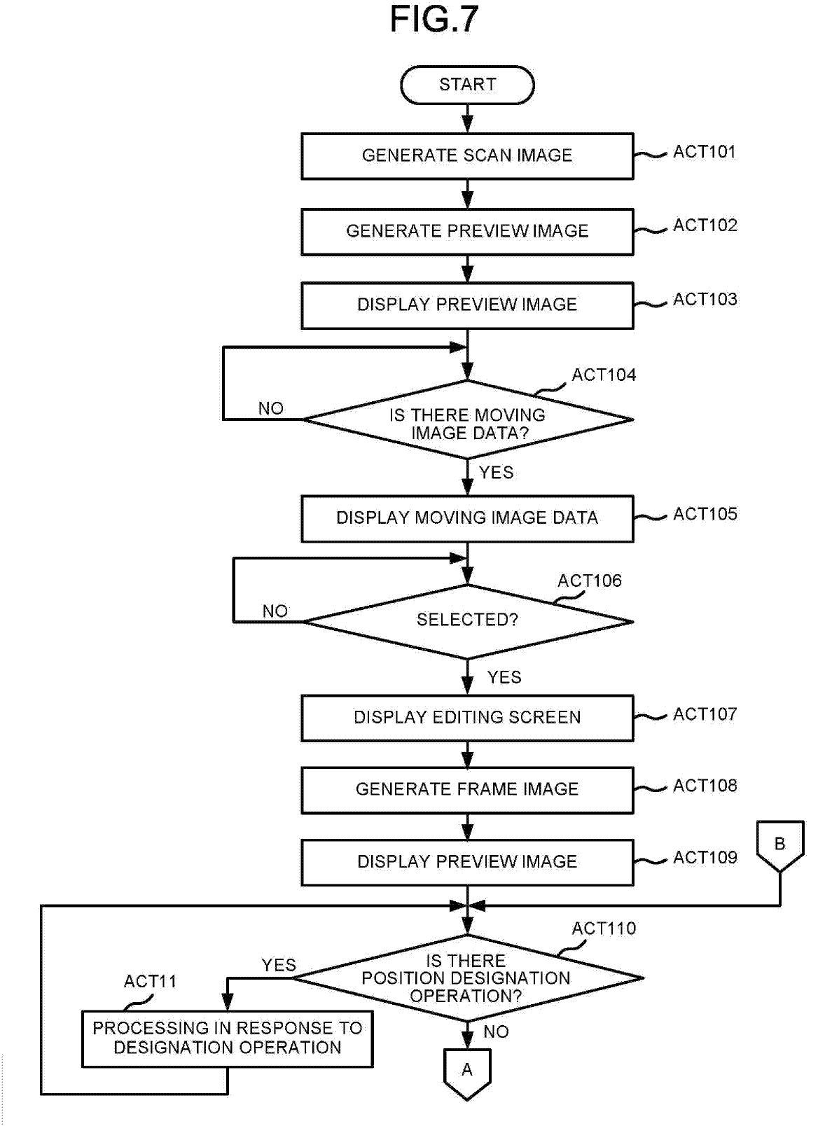

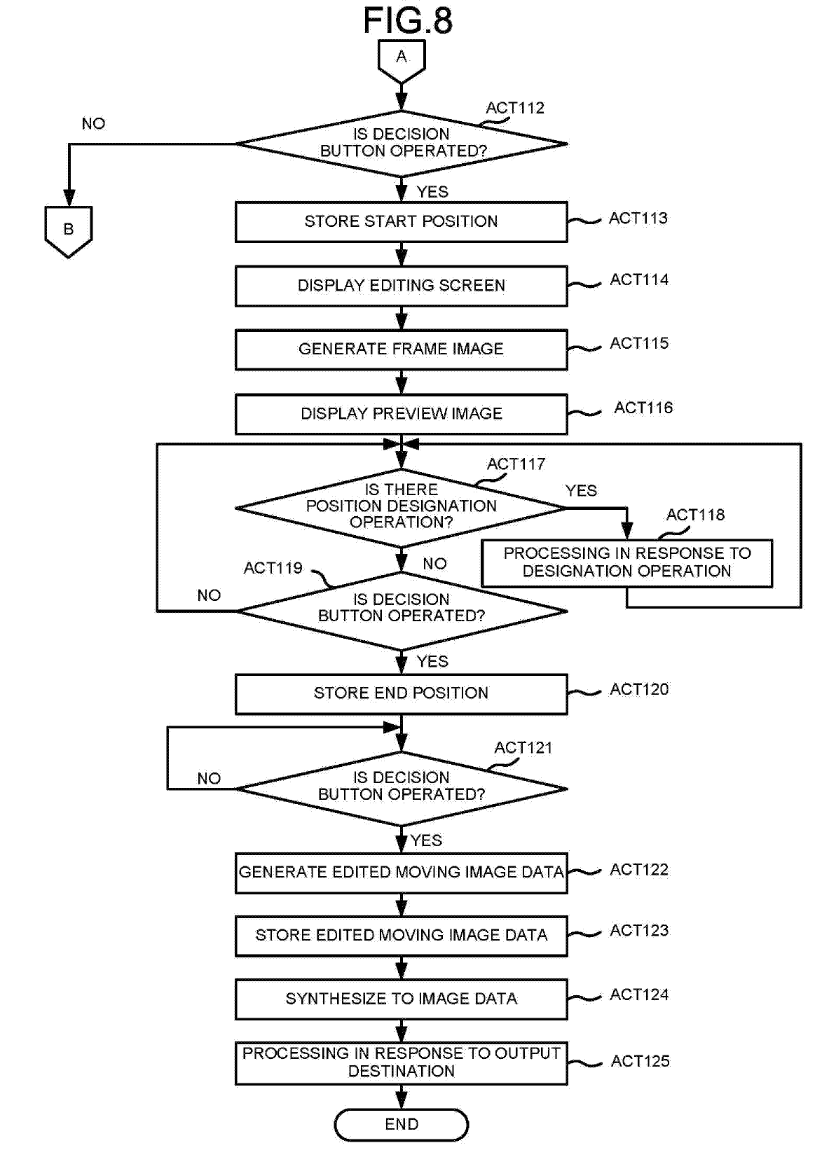

FIG. 7 and FIG. 8 are flowcharts illustrating the flow of the processing of the image processing apparatus 100 according to the first embodiment. The processing in FIG. 7 and FIG. 8 is executed when the user designates the scan mode in which the moving image data is associated with the scanned image data.

The scanner image processing section 203 generates the scan image data from the image data generated by reading the sheet (ACT 101). The scanner image processing section 203 outputs the generated scan image data to the page memory controller 301. The page memory controller 301 writes the output scan image data to the page memory 302.

The preview image generation section 312 generates a preview image from the generated scan image data (ACT 102). The preview image generation section 312 outputs the generated preview image to the control panel controller 310. The control panel controller 310 displays the output preview image on the display 110 (ACT 103). For example, the control panel controller 310 displays the preview image in the area 350 in the moving image selection screen 111.

The CPU 303 determines whether or not there is moving image data (ACT 104). Specifically, the CPU 303 determines that there is moving image data if there is moving image data in the external memory or/and the auxiliary storage device 308. On the other hand, the CPU 303 determines that there is no moving image data if there is no moving image data in either the external memory or the auxiliary storage device 308. If there is no moving image data (No in ACT 104), the CPU 303 waits until the moving image data is detected.

On the other hand, if there is moving image data detected (Yes in ACT 104), the CPU 303 acquires the moving image data from the external memory or/and the auxiliary storage device 308. At this time, the CPU 303 may acquire all moving image data items, or may acquire a predetermined amount of the moving image data items. The CPU 303 outputs the acquired moving image data item to the control panel controller 310. The control panel controller 310 displays the output moving image data items on the display 110 (ACT 105). For example, the control panel controller 310 displays the file name of each moving image data item in the area 360 in the moving image selection screen 111.

The control panel controller 310 determines whether or not one of the moving image data items is selected (ACT 106). If one of the moving image data items is not selected (No in ACT 106), the control panel controller 310 waits for until one of the moving image data items is selected.

On the other hand, if one of the moving image data items is selected (Yes in ACT 106), the control panel controller 310 displays the editing screen 112 for selecting the start position on the display 110. The control panel controller 310 switches the screen from the moving image selection screen 111 shown in FIG. 3 to the editing screen 112 shown in FIG. 4. As a result, the display 110 displays the editing screen 112 (ACT 107). If the switching to the editing screen 112 is executed, the control panel controller 310 notifies the preview moving image generation section 313 that the switching is made. Further, the control panel controller 310 provides the preview moving image generation section 313 the information (e.g., file name) for specifying the selected moving image data.

The preview moving image generation section 313 acquires the moving image data indicated by the information acquired from the control panel controller 310 from the page memory 302. The preview moving image generation section 313 generates the frame image from the acquired moving image data. Then, the preview moving image generation section 313 performs the processing and editing according to the layout of the display on the display 110 to generate a preview image of the moving image data (ACT 108). The preview moving image generation section 313 outputs the generated preview image to the control panel controller 310. The control panel controller 310 displays the output preview image of the moving image data on the display 110 (ACT 109). For example, the control panel controller 310 displays the preview image of the moving image data in the area 360 in the moving image selection screen 111.

The control panel controller 310 determines whether or not a position designation operation is performed (ACT 110). If the position designation operation is performed (Yes in ACT 110), the control panel controller 310 executes the processing in response to the position designation operation (ACT 111). Specifically, if the start position is set by the user, the control panel controller 310 outputs the information on the start position to the preview moving image generation section 313. The preview moving image generation section 313 generates the preview image as the frame image corresponding to the position output from the control panel controller 310. The preview moving image generation section 313 outputs the generated preview image to the control panel controller 310. The control panel controller 310 displays the output preview image of the moving image data on the display 110.

On the other hand, if there is no position designation operation (No in ACT 110), the control panel controller 310 determines whether or not the decision button is operated (ACT 112). If the decision button is not operated (No in ACT 112), the control panel controller 310 repeatedly executes the processing subsequent to ACT 110.

On the other hand, if the decision button is operated (Yes in ACT 112), the control panel controller 310 stores the information of the start position (ACT 113).

Next, the control panel controller 310 displays the editing screen 112 for selecting the end position on the display 110. As a result, the display 110 displays the editing screen 112 (ACT 114). If the editing screen 112 is switched by the control panel controller 310, the control panel controller 310 notifies the preview moving image generation section 313 of the switching. At this time, the control panel controller 310 provides the information on the initial position to the preview moving image generation section 313. The information on the initial position provided at this time is the start position.

The preview moving image generation section 313 identifies the frame image corresponding to the position output from the control panel controller 310, and generates the preview image (ACT 115). The preview moving image generation section 313 outputs the generated preview image to the control panel controller 310. The control panel controller 310 displays the output preview image of the moving image data on the display 110 (ACT 116). Thereafter, the control panel controller 310 determines whether or not the position designation operation is input (ACT 117).

If the position designation operation is input (Yes in ACT 117), the control panel controller 310 executes a processing in response to the designation operation (ACT 118). Specifically, if the end position is set by the user, the control panel controller 310 outputs the information on the end position to the preview moving image generation section 313. The preview moving image generation section 313 generates the preview image based on the frame image corresponding to the position output from the control panel controller 310. The preview moving image generation section 313 outputs the generated preview image to the control panel controller 310. The control panel controller 310 displays the output preview image of the moving image data on the display 110.

On the other hand, if there is no position designation operation (No in ACT 117), the control panel controller 310 determines whether or not the decision button is operated (ACT 119). If the decision button is not operated (No in ACT 119), the control panel controller 310 repeatedly executes the processing subsequent to ACT 117.

On the other hand, if the decision button is operated (Yes in ACT 119), the control panel controller 310 stores the information of the end position (ACT 120).

Thereafter, the control panel controller 310 displays the setting screen 113 on the display 110. The control panel controller 310 displays the setting screen 113 shown in FIG. 5 on the display 110. The control panel controller 310 determines whether or not the decision button is operated (ACT 121).

If the decision button is not operated (No in ACT 121), the control panel controller 310 waits for until the decision button is operated. Although not shown, if the return button 372 is operated, the control panel controller 310 switches the screen from the setting screen 113 to the editing screen 112.

On the other hand, if the decision button is operated (Yes in ACT 121), the control panel controller 310 instructs the association processing of the moving image data. Specifically, the control panel controller 310 outputs the information of the set start position and the set end position to the moving image editing section 316. The control panel controller 310 instructs the link information generation section 315 to generate the association information. At this time, the control panel controller 310 outputs the edited moving image data name and the information of the storage destination displayed in the edited information 381 of the setting screen 113 to the link information generation section 315.

The moving image editing section 316 generates the edited moving image data based on the information of the start position and the end position output from the control panel controller 310 (ACT 122). Specifically, the moving image editing section 316 generates the edited moving image data by deleting the moving image part excluding a range indicated by the start position and the end position from the moving image data. The moving image editing section 316 stores the generated edited moving image data in a predetermined storage destination of the auxiliary storage device 308 (ACT 123).

The link information generation section 315 generates the association information based on the edited moving image data name output from the control panel controller 310 and the storage destination. Thereafter, the link information generation section 315 generates the synthesized image data by synthesizing the generated association information with the scan image data (ACT 124). The link information generation section 315 stores the generated synthesized image data in the predetermined storage destination of the auxiliary storage device 308.

In addition, the image processing apparatus 100 executes the processing in response to the output destination of the synthesized image data (ACT 125). For example, if the output of the synthesized image data is an output by printing, the CPU 303 controls the printer section 130 to print and output the synthesized image data. For example, if the output of the synthesized image data is an output by electronic data, the CPU 303 edits the association information into a hyperlink and outputs it.

According to the image processing apparatus 100 as described above, only the necessary part of the moving image data can be associated with the scan image data. As a result, it is possible to save the time and labor for selecting the necessary part of the original, longer moving image data and to minimize the memory size of the moving image data to be stored in association with the scan image data. Therefore, the user can handle it easily and the convenience can be greatly

### Second Embodiment

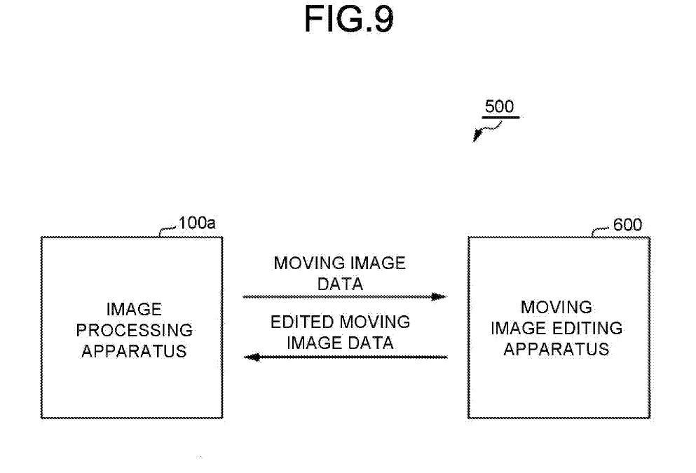

FIG. 9 is a diagram illustrating the general arrangement of an image editing system 500 according to the second embodiment. The image editing system 500 includes an image processing apparatus 100a and a moving image editing apparatus 600.

The image processing apparatus 100a is a multi-functional peripheral capable of forming a toner image on a sheet. The image processing apparatus 100a communicates with the moving image editing apparatus 600 and a shared information holding server 700 via a network. The image processing apparatus 100a transmits the moving image data selected by the user to the moving image editing apparatus 600 and acquires the edited moving image data from the moving image editing apparatus 600.

The moving image editing apparatus 600 is an information processing apparatus such as a personal computer. The moving image editing apparatus 600 generates the edited moving image data by editing the moving image data sent from the image processing apparatus 100a.

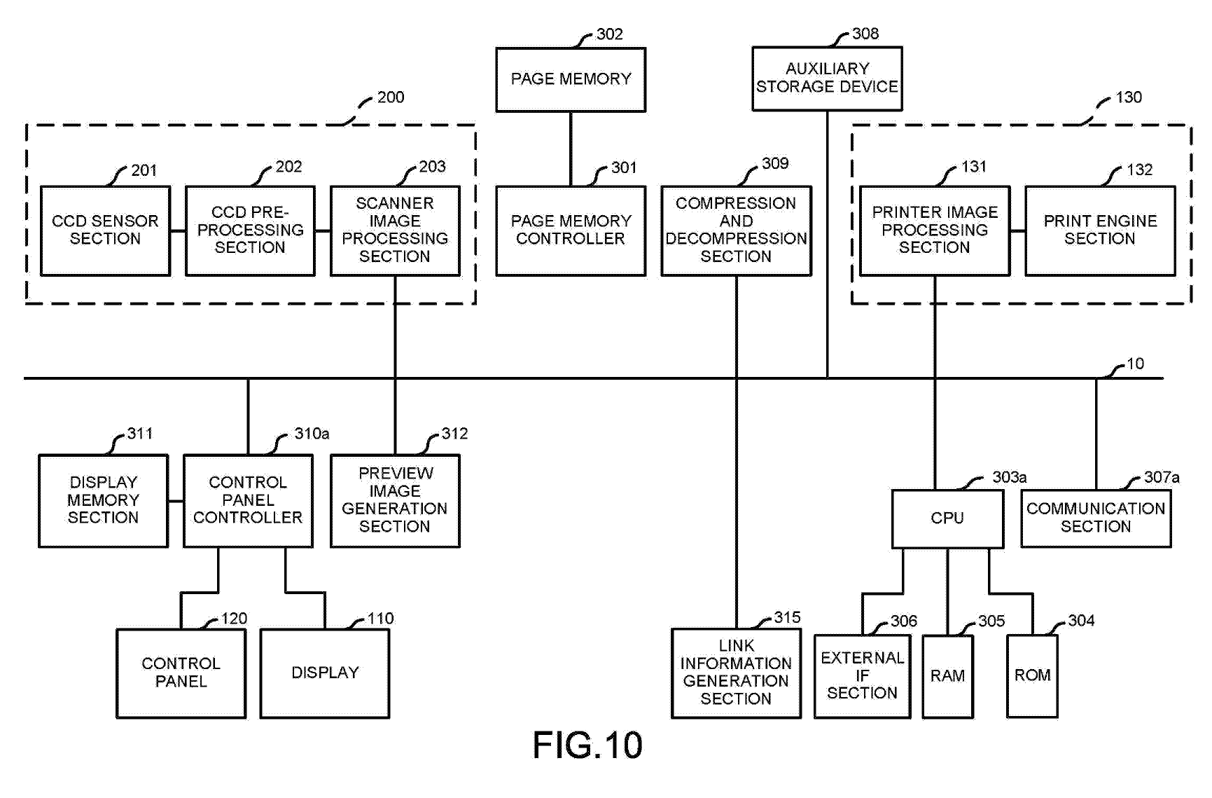

FIG. 10 is a block diagram illustrating the functional components of the image processing apparatus 100a according to the second embodiment. The printer section 130 includes the printer image processing section 131 and the print engine section 132. The image reading section includes the CCD sensor section 201, the CCD pre-processing section 202, and the scanner image processing section 203. The image processing apparatus 100a further includes the page memory controller 301, the page memory 302, a CPU 303a, the ROM 304, the RAM 305, the external IF section 306, a communication section 307a, the auxiliary storage device 308, the compression and decompression section 309, a control panel controller 310a, the display memory section 311, the preview image generation section 312, the link information generation section 315 and the moving image editing section 316. The preview image generation section 312, the link information generation section 315 and the moving image editing section 316 are implemented by, for example, the CPU 303a.

The image processing apparatus 100a includes the CPU 303a, the communication section 307a and the control panel controller 310a instead of the CPU 303, the communication section 307 and the control panel controller 310. The image processing apparatus 100a does not include the preview moving image generation section 313 and the time management section 314, and is thereby different from the image processing apparatus 100. The image processing apparatus 100a is similar to the image processing apparatus 100 in other components. Therefore, the description of the whole image processing apparatus 100a is omitted, and only the CPU 303a, the communication section 307a and the control panel controller 310a are described.

The CPU 303a controls each functional section according to a program stored in the ROM 304. The CPU 303a controls the communication section 307a to send the moving image data selected by the user to the moving image editing apparatus 600. The CPU 303a stores the edited moving image data received by the communication section 307a in the auxiliary storage device 308 and instructs the link information generation section 315 to generate association information.

The communication section 307a communicates with the moving image editing apparatus 600 connected to the network. For example, the communication section 307a transmits the moving image data to the moving image editing apparatus 600, and receives the edited moving image data from the moving image editing apparatus 600.

The control panel controller 310a controls the display 110, the control panel 120, and the display memory section 311. The control panel controller 310a controls information displayed on a predetermined screen and input of operations by the user through the touch panel. The control panel controller 310a displays the image stored in the display image area of the display memory section 311 on the display 110. The control panel controller 310a changes the image displayed on the display 110 by rewriting the display memory section 311. The control panel controller 310a notifies the CPU 303a of the selection of the moving image data if the moving image data is selected.

FIG. 11 is a block diagram illustrating the functional components of the moving image editing apparatus 600. The moving image editing apparatus 600 includes a communication section 601, a controller 602, an operation section 603, a display section 604, a preview moving image generation section 605, a time management section 606, an auxiliary storage device 607 and a moving image editing section 608. The functions of the moving image editing apparatus 600 are communicably connected via a bus line 60. The preview moving image generation section 605, the time management section 606 and the moving image editing section 608 are implemented by, for example, a CPU.

The communication section 601 communicates with the image processing apparatus 100. The communication section 601 communicates with the shared information holding server 700.

The controller 602 controls each functional section of the moving image editing apparatus 600.

The operation section 603 is an existing input device such as a keyboard, a pointing device (a mouse, a tablet, etc.), a touch panel, and a button. The operation section 603 is operated by the user at the time of inputting an instruction of the user to the moving image editing apparatus 600. The operation section 603 may be an interface for connecting an input device to the moving image editing apparatus 600. In this case, the operation section 603 provides an input signal generated according to the input by the user in the input device to the moving image editing apparatus 600.

The display section 604 is an image display device such as a liquid crystal display or an organic EL (Electro Luminescence) display. The display section 604 displays the moving image data received by the communication section 601. The display section 604 may be an interface for connecting an image display device to the moving image editing apparatus 600. In this case, the display section 604 generates a video signal for displaying the moving image data and outputs the video signal to the image display device connected to the moving image editing apparatus 600.

The preview moving image generation section 605 generates a frame image from the moving image data, performs processing and editing on it according to the layout of the display of the display section 604, and generates a preview image of the moving image data.

The time management section 606 manages the time/position in the moving image data of the frame image generated as the preview image in the preview moving image generation section 605.

The auxiliary storage device 607 is a storage device such as a magnetic hard disk device or a semiconductor storage device. The auxiliary storage device 607 stores the moving image data.

The moving image editing section 608 edits the moving image data based on the information of the designated start position and the designated end position. For example, the moving image editing section 608 generates the moving image data obtained by deleting the moving image parts other than the designated time in the moving image data.

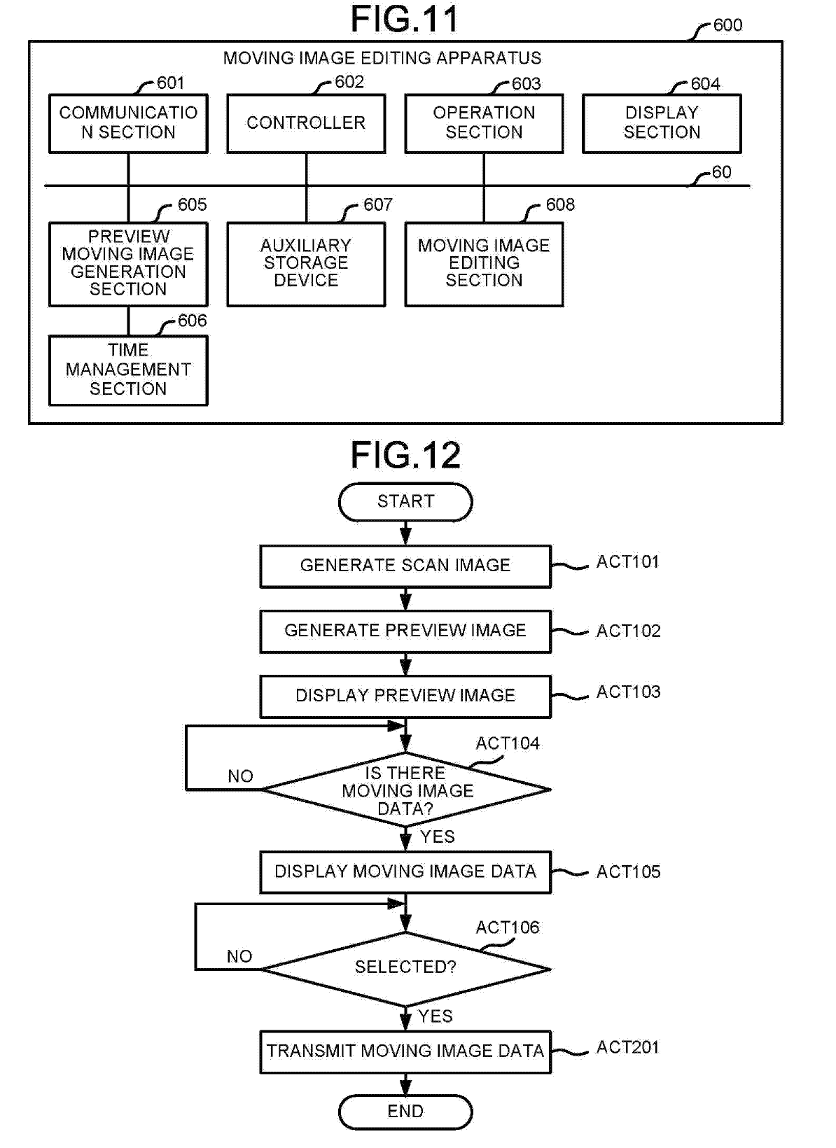

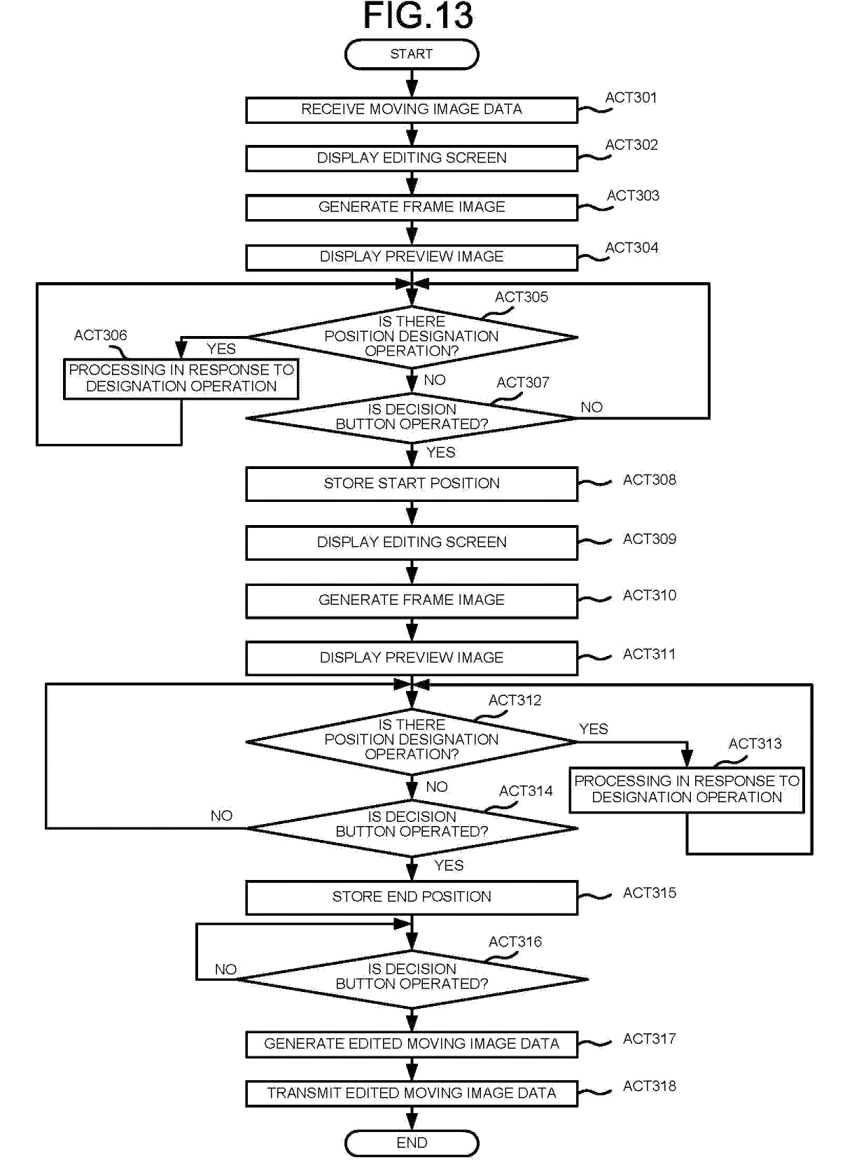

FIG. 12 is a flowchart illustrating the flow of a moving image data transmission processing by the image processing apparatus 100a according to the second embodiment. In FIG. 12, the processing similar to that in FIG. 5 is denoted with the same reference numeral as that in FIG. 5, and the description thereof is omitted.

In the processing in ACT 106, if the moving image data is selected (Yes in ACT 106), the control panel controller 310 notifies the CPU 303a of the information (e.g., file name) for specifying the selected moving image data. Based on the notified information, the CPU 303a acquires the moving image data corresponding to the notified information from the page memory 302. Since the moving image data stored in the page memory 302 is compressed, the CPU 303a acquires the moving image data decompressed by the compression and decompression section 309. The CPU 303a controls the communication section 307a to transmit the acquired moving image data to the moving image editing apparatus 600 (ACT 201).

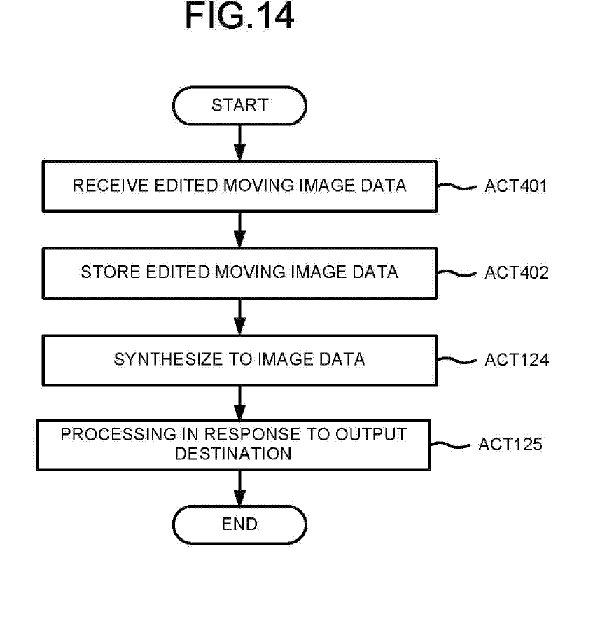

FIG. 13 is a flowchart illustrating the flow of the moving image editing processing of the moving image editing apparatus 600 according to the second embodiment.

The communication section 601 receives the moving image data transmitted from the image processing apparatus 100a (ACT 301). The communication section 601 outputs the received moving image data to the controller 602. The controller 602 stores the output moving image data in the auxiliary storage device 607. If the instruction for editing the moving image is received via the operation section 603, the controller 602 displays an editing screen on the display section 604 (ACT 302). The editing screen displayed on the display section 604 may be a screen excluding the area 350 among the areas displayed in the editing screen 112 shown in FIG. 4.

If the editing screen is displayed, the preview moving image generation section 605 generates a frame image from the moving image data stored in the auxiliary storage device 607 (ACT 303). Thereafter, the preview moving image generation section 605 performs processing and editing according to the layout of the display on the display section 604 to generate a preview image of the moving image data. The preview moving image generation section 605 outputs the generated preview image to the controller 602. The controller 602 displays the output preview image of the moving image data on the display section 604 (ACT 304).

The controller 602 determines whether or not a position designation operation is performed (ACT 305). If there is the position designation operation (Yes in ACT 305), the controller 602 executes a processing in response to the designation operation (ACT 306). Specifically, if the start position is set by the user, the controller 602 outputs the information on the start position to the preview moving image generation section 605. The preview moving image generation section 605 generates a preview image from the frame image corresponding to the start position output from the controller 602. The preview moving image generation section 605 outputs the generated preview image to the controller 602. The controller 602 displays the output preview image of the moving image data on the display section 604.

On the other hand, if there is no position designation operation (No in ACT 305), the controller 602 determines whether or not the decision button is operated (ACT 307). If the decision button is not operated (No in ACT 307), the controller 602 repeatedly executes the processing subsequent to ACT 305.

On the other hand, if the decision button is operated (Yes in ACT 305), the controller 602 stores the information on the start position (ACT 308).

Next, the controller 602 displays an editing screen for selecting the end position on the display section 604. Thus, the display section 604 displays the editing screen for selecting the end position (ACT 309). If the switching to the editing screen is performed by the controller 602, the controller 602 notifies the preview moving image generation section 605 of the switching. At this time, the controller 602 provides the information of the initial position to the preview moving image generation section 605. The information on the initial position is the information on the start position.

The preview moving image generation section 605 generates a frame image corresponding to the position output from the controller 602, and generates a preview image (ACT 310). The preview moving image generation section 605 outputs the generated preview image to the controller 602. The controller 602 displays the output preview image of the moving image data on the display section 604 (ACT 311). Thereafter, the controller 602 determines whether or not the position designation operation is received (ACT 312).

If the position designation operation is received (Yes in ACT 312), the controller 602 executes a processing in response to the designation operation (ACT 313). Specifically, if the end position is set by the user, the controller 602 outputs the information of the end position to the preview moving image generation section 605. The preview moving image generation section 605 generates a preview image from the frame image corresponding to the position output from the controller 602. The preview moving image generation section 605 outputs the generated preview image to the controller 602. The controller 602 displays the preview image of the output moving image data on the display section 604.

On the other hand, if there is no position designation operation (No in ACT 312), the controller 602 determines whether or not the decision button is operated (ACT 314). If the decision button is not operated (No in ACT 314), the controller 602 repeatedly executes the processing subsequent to ACT 312.

On the other hand, if the decision button is operated (Yes in ACT 314), the controller 602 stores the information on the end position (ACT 315).

Thereafter, the controller 602 displays a setting screen on the display section 604. The setting screen displayed on the display section 604 may be a screen excluding the area 350 and the edited information 381 among the areas displayed on the setting screen shown in FIG. 5. The controller 602 determines whether or not the decision button is operated (ACT 316).

If the decision button is not operated (No in ACT 316), the controller 602 waits until the decision button is operated. The controller 602 switches the screen from the setting screen to the editing screen if the return button is operated.

If the decision button is operated (Yes in ACT 316), the controller 602 instructs the execution of the editing processing of the moving image data. Specifically, the controller 602 outputs the information of the decided start position and end position to the moving image editing section 608. The moving image editing section 608 generates the edited moving image data based on the information of the start position and the end position output from the controller 602 (ACT 317). Specifically, the moving image editing section 608 generates the edited moving image data by deleting the moving image parts excluding the range indicated by the start position and end position from the moving image data. The moving image editing section 608 outputs the generated edited moving image data to the controller 602. The controller 602 controls the communication section 601 to send the edited moving image data to the image processing apparatus 100a (ACT 318).

FIG. 14 is a flowchart illustrating the flow of a moving image data synthesis processing of the image processing apparatus 100a according to the second embodiment. In FIG. 14, the processing similar to that in FIG. 8 is denoted with the same reference numeral as that in FIG. 8, and the description thereof is omitted.

The communication section 307a receives the edited moving image data transmitted from the moving image editing apparatus 600 (ACT 401). The communication section 307a outputs the received edited moving image data to the CPU 303a. The CPU 303a stores the output edited moving image data in a predetermined storage destination of the auxiliary storage device 308 (ACT 402). Thereafter, the CPU 303a outputs the association information of the edited moving image data name and the storage destination to the link information generation section 315, and instructs the generation of the association information. After that, the processing subsequent to ACT 124 is executed.

According to the image processing apparatus 100a as described above, the same effect as in the first embodiment can be obtained.

The image processing apparatus 100a does not need to execute the moving image editing processing. Therefore, the processing load can be reduced.

Modifications common to the first embodiment and the second embodiment are described.

The association information may be a two-dimensional barcode such as QR code (registered trademark).

The image processing apparatus 100 may be an image reading apparatus that does not have an image forming section to form an image.

According to the image processing apparatus of at least one embodiment described above, the convenience of a user and processing load of the image processing apparatus 100 can be improved.

The functions of the image processing apparatus 100, the image processing apparatus 100a and the moving image editing apparatus 600 according to the foregoing embodiments may be realized by a computer. In this case, programs for realizing the functions are storing in a computer-readable recording medium and the functions may be realized by transferring the programs recorded in the recording medium into a computer system and executing the programs. Further, it is assumed that the “computer system” described herein contains an OS or hardware such as peripheral devices. Further, the “computer-readable recording medium” refers to a portable medium such as a flexible disk, a magneto-optical disk, a ROM, a CD-ROM and the like or a storage device such as a hard disk built in the computer system. Furthermore, the “computer-readable recording medium” refers to a medium for holding the programs for a certain time like a volatile memory in the computer system serving as a server and a client. The foregoing programs may realize a part of the above-mentioned functions, and the above-mentioned functions may be realized by combining the foregoing program with a program already recorded in the computer.

While certain embodiments have been described, these embodiments have been presented by way of example only, and are not intended to limit the scope of the invention. Indeed, the novel embodiments described herein may be embodied in a variety of other forms; furthermore, various omissions, substitutions and changes in the form of the embodiments described herein may be made without departing from the spirit of the invention. The accompanying claims and their equivalents are intended to cover such forms or modifications as would fall within the scope and spirit of the invention.

What is claimed is:

1. An image processing apparatus, comprising:
an image reading device configured to generate image data by reading a sheet; and
a processor configured to:
perform an editing processing on moving image data to generate edited moving image data,
generate synthesized image data by adding information corresponding to the edited moving image data to the generated image data, and
output the generated synthesized image data.

2. The apparatus according to claim 1, wherein performing the editing processing on the moving image data includes:
receiving user input regarding at least one of a designated starting place and a designated ending place of the received moving image data, and
deleting a part of the received moving image data that is not included in a range defined by the at least one designated starting place and designated ending place.

3. The apparatus according to claim 1, wherein performing the editing processing on the moving image data includes:
receiving user input regarding at least one of a designated starting place and a designated ending place of the received moving image, and
extracting, as the edited moving image data, a part of the received moving image that is included in a range defined by the at least one designated starting place and designated ending place.

4. The apparatus according to claim 1, wherein:
the processor is further configured to control a storage device to store the edited moving image data, and
the information corresponding to the edited moving image includes an identification and storage location of the edited moving image data.

5. The apparatus according to claim 4, wherein outputting the generated synthesized image data includes printing an image corresponding to the synthesized image data.

6. The apparatus according to claim 5, wherein the printed image includes a scannable code that can be scanned to extract the identification and storage location of the edited moving image data.

7. The apparatus according to claim 1, wherein outputting the generated synthesized image data includes outputting the synthesized image data as electronic data, wherein the information corresponding to the edited moving image is included in the output synthesized image data as a hyperlink.

8. The apparatus according to claim 1, further comprising:
a display device, wherein
the processor is further configured to:
receive a plurality of moving image data items, control the display device to display a selection screen
for selecting one of the plurality of moving image data items as the moving image data on which the editing processing is performed.

9. The apparatus according to claim 8, wherein the processor is further configured to:
control the display device to display an editing screen for performing the editing processing, the editing screen including a preview image of the selected one of the plurality of moving image data items as the moving image data on which the editing processing is performed.

10. The apparatus according to claim 1, wherein a memory size of the generated edited moving image data is smaller than a memory size of the received moving image data.

11. An image editing system comprising:
an image processing apparatus; and
an information processing apparatus in communication with the image processing apparatus, wherein
the image processing apparatus includes:
an image reading device configured to generate image data by reading a sheet, and
a first processor configured to:
retrieve moving image data from a storage device,
transmit the moving image data to the information processing apparatus,
receive edited moving image data from the information processing apparatus,
generate synthesized image data by adding information corresponding to the edited moving image data to the generated image data, and
output the generated synthesized image data, and
the information processing apparatus includes:
a second processor configured to:
receive the moving image data from the storage device,
perform an editing processing on the moving image data to generate the edited moving image data, and
transmit the edited moving image data to the image processing apparatus.

12. The system according to claim 11, wherein performing the editing processing on the moving image data includes:
receiving user input regarding at least one of a designated starting place and a designated ending place of the received moving image data, and
deleting a part of the received moving image data that is not included in a range defined by the at least one designated starting place and designated ending place.

13. The system according to claim 11, wherein performing the editing processing on the moving image data includes:
receiving user input regarding at least one of a designated starting place and a designated ending place of the received moving image, and
extracting, as the edited moving image data, a part of the received moving image that is included in a range defined by the at least one designated starting place and designated ending place.

14. The system according to claim 11, wherein:
the first processor is further configured to control a storage device to store the edited moving image data, and
the information corresponding to the edited moving image includes an identification and storage location of the edited moving image data.

15. The system according to claim 14, wherein outputting the generated synthesized image data includes printing an image corresponding to the synthesized image data.

16. The system according to claim 15, wherein the printed image includes a scannable code that can be scanned to extract the identification and storage location of the edited moving image data.

17. The system according to claim 11, wherein outputting the generated synthesized image data includes outputting the synthesized image data as electronic data, wherein the information corresponding to the edited moving image is included in the output synthesized image data as a hyperlink.

18. The system according to claim 17, wherein:
the information processing device further includes a display device, and the second processor is further configured to:
control the display device to display an editing screen for performing the editing processing, the editing screen including a preview image of the selected one of the plurality of moving image data items as the moving image data on which the editing processing is performed.

19. The system according to claim 11, wherein a memory size of the generated edited moving image data is smaller than a memory size of the received moving image data.

20. An image processing method, comprising:
generating image data by reading a sheet with a scanner;
performing an editing processing on moving image data to generate edited moving image data;
generating synthesized image data by adding information corresponding to the edited moving image data to the generated image data; and
outputting the generated synthesized image data.
